(19) United States
(12) Patent Application Publication
(10) Pub. No.: US 2024/0322333 A1
(43) Pub. Date: Sep. 26, 2024

(54) BATTERY REPLACEMENT SYSTEM AND METHOD

(71) Applicant: SAMSUNG SDI CO., LTD., Yongin-si (KR)

(72) Inventor: Minsu KIM, Yongin-si (KR)

(21) Appl. No.: 18/496,537

(22) Filed: Oct. 27, 2023

(30) Foreign Application Priority Data
Mar. 22, 2023 (KR) 10-2023-0037526

(51) Int. Cl. H01M 50/244; G01S 1/68; G06T 7/70; H01M 10/42; H01M 50/204; H01M 50/258

(52) U.S. Cl. CPC H01M 50/244; G01S 1/68; G06T 7/70; H01M 10/4221; H01M 50/204; H01M 50/258

(57) ABSTRACT

One or more embodiments provides a battery replacement system including antennas, a camera, a first controller configured to generate position information of a first target battery module based on image data received from the camera and corresponding to battery modules inside a battery pack, and based on a beacon signal received from the first target battery module through the antennas, and a battery module replacement device configured to replace the first target battery module with a new battery module based on the position information.

### CROSS-REFERENCE TO RELATED APPLICATION

This application claims priority to, and the benefit of, Korean Patent Application No. 10-2023-0037526 filed Mar. 22, 2023, in the Korean Intellectual Property Office, the entire contents of which are incorporated herein by reference.

### BACKGROUND

### 1. Field

The present disclosure relates to a battery replacement system and method.

### 2. Description of Related Art

A rechargeable or secondary battery differs from a primary battery, which provides only irreversible conversion of chemical materials into electrical energy, in that the rechargeable or secondary battery can be charged and discharged repeatedly. Low-capacity rechargeable batteries are used as power supplies for small electronic devices, such as mobile phones, notebook computers, and camcorders, while high-capacity rechargeable batteries are used as power supplies, such as an energy storage system (ESS) or uninterruptible power supply (UPS) system using medium and large batteries used for electric vehicles (EVs), hybrid vehicles (HVs), or home or industry.

In general, the secondary battery includes an electrode assembly including a positive electrode, a negative electrode, a separator interposed between the positive and negative electrodes, a case accommodating the electrode assembly, and an electrode terminal electrically connected to the electrode assembly. An electrolyte solution is injected into the case to enable charging and discharging of the battery through an electrochemical reaction between the positive electrode, the negative electrode, and the electrolyte solution. A shape of the case, such as a cylindrical or rectangular shape, depends on the purpose of the battery.

The rechargeable battery may be used as a battery module formed of a plurality of unit battery cells connected in series and/or in parallel to provide high energy density, for example, for driving a motor of a hybrid vehicle. That is, the battery module is formed by interconnecting electrode terminals of a plurality of unit battery cells according to an amount of power required to implement, for example, a high-power rechargeable battery for an electric vehicle. One or more battery modules are mechanically and electrically integrated to configure a battery pack.

To meet dynamic power demands of various electrical consumer devices connected to the battery pack, static control of battery power output and charging operation is not sufficient. Accordingly, information must be constantly or intermittently exchanged between the battery pack and the controllers of the electrical consumer devices. This information includes actual state of charge (SOC), potential electrical performance, charging capability, and internal resistance of the battery pack, as well as actual or projected power demand, or consumer surplus, of the battery pack.

For monitoring, control, and/or setting of the aforementioned parameters, the battery pack includes control electronics. These control electronics may be essential components of the battery pack, may be located in a common housing, or may be a part of a remote-control unit that communicates with the battery pack through an appropriate communication bus. These control electronics may perform various functions in the battery pack.

The control electronics of the battery pack, for example, a battery system manager (BSM), a battery management system (BMS), a battery monitoring unit (BMU), or a system basis chip (SBC) may be powered by the battery pack controlled by them. In this way, an additional power source for the control electronics may be omitted, thereby reducing the installation space requirement of the battery pack. However, depending on the output voltage of the battery pack, for example, a high voltage battery pack, such as an output voltage 48 V, may suitably use adjustment of the output voltage to supply power to the control electronics.

The battery module has a limited cycle-life due to deterioration, and may be placed in an unusable state due to a failure. Conventionally, when the cycle-life of the battery module is exhausted, or when the battery module is out of order, the battery module may be replaced in such a way that the entire battery pack is replaced, regardless of a number of battery modules that have exhausted their cycle-life or that are out of order. This method is very economically inefficient, because one or more normally operating battery modules are also replaced.

### SUMMARY

Embodiments provide a battery replacement system, and a method that may automatically identify and replace only defective battery modules.

One or more embodiments provide a battery replacement system including antennas, a camera, a first controller configured to generate position information of a first target battery module based on image data received from the camera and corresponding to battery modules inside a battery pack, and based on a beacon signal received from the first target battery module through the antennas, and a battery module replacement device configured to replace the first target battery module with a new battery module based on the position information.

The first controller may be further configured to detect module areas corresponding to the battery modules based on the image data, to determine a target module area of the first target battery module based on the beacon signal, to generate the position information of the first target battery module to include target module area information of the first target battery module, and to generate identification information extracted from the beacon signal.

The first controller may be further configured to determine the target module area based on a received signal strength of the antennas for the beacon signal.

The antennas may be configured to receive beacon signals transmitted from the battery modules, wherein the first controller is further configured to generate position information of the battery modules based on the image data and the beacon signal.

The first controller may be further configured to determine one of the battery modules not transmitting the beacon signal as a second target battery module, and to generate second target position information of the second target battery module based on the image data, wherein the battery module replacement device is further configured to replace the second target battery module with a new battery module based on the second target position information.

The first controller may be further configured to determine one of the battery modules whose corresponding module area is not transmitting the beacon signal.

The battery replacement system may further include a second controller configured to receive information on one of the battery modules to be replaced from the battery pack, and to receive position information of the battery modules from the first controller, wherein the second controller is further configured to select the first target battery module based on the information of the one of the battery modules to be replaced, and to transmit first target position information of the first target battery module to the battery module replacement device.

The first controller may be further configured to select the first target battery module based on the information of the one of the battery modules to be replaced, and to transmit position information of the first target battery module to the battery module replacement device.

The position information of the first target battery module may include module area information of the first target battery module, and identification information of the first target battery module detected from the beacon signal.

The battery module replacement device may be further configured to determine an operation path for replacing the first target battery module based on the position information of the first target battery module, and to replace the first target battery module with the new battery module based on the operation path.

One or more other embodiments provide a battery replacement method of a battery replacement system, the method including obtaining image data by capturing an image of battery modules inside a battery pack via a camera, receiving a beacon signal from a first target battery module among the battery modules through antennas, generating position information of the first target battery module based on the image data and the beacon signal, and replacing the first target battery module with a new battery module based on the position information of the first target battery module.

The generating of the position information may include detecting module areas corresponding to the battery modules from the image data, determining a first target module area of the first target battery module from among the module areas based on the beacon signal, and generating position information of the first target battery module to include module area information of the first target battery module and identification information extracted from the beacon signal.

The determining of the module area of the first target battery module may be based on a signal strength of the antennas for the beacon signal.

The battery replacement method may further include receiving beacon signals transmitted from the battery modules via the antennas, determining a second target battery module not transmitting a beacon signal among the battery modules, generating position information of the second target battery module based on the image data, and replacing the second target battery module with a new battery module based on the position information.

The determining of the second target battery module may include determining the second target battery module corresponds to a module area whose beacon signal is not received through the antennas.

The battery replacement method may further include receiving, from the battery pack, information corresponding to a battery module to be replaced, and determining the first target battery module based on the information.

The position information of the first target battery module may include module area information of the first target battery module and identification information of the first target battery module detected from the beacon signal.

The replacing may include determining an operation path for replacing the first target battery module based on the position information of the first target battery module, and replacing the first target battery module with the new battery module based on the operation path.

The battery replacement method may further include receiving a diagnostic result for the new battery module from the battery pack, and completing assembly of the battery pack based on determining that the new battery module is normally replaced based on the diagnostic result.

The battery replacement method may further include detecting reception of the battery pack at a replacement location, and performing an authentication process for battery module replacement by wirelessly communicating with the battery pack.

According to the embodiments, by automatically identifying and replacing only defective battery modules, it is possible to improve efficiency of battery module replacement, and to reduce or prevent the likelihood of unnecessary battery module replacement.

### BRIEF DESCRIPTION OF THE DRAWINGS

FIG. 1 schematically illustrates a battery replacement system according to one or more embodiments.

FIG. 2 illustrates a perspective view of an example of a module identification device according to one or more embodiments.

FIG. 3 illustrates a method of identifying a position of a battery module by a module identification device according to one or more embodiments.

FIG. 4 schematically illustrates a flowchart of a battery replacement method according to one or more embodiments.

FIG. 5 schematically illustrates a flowchart of a method for generating replacement map data according to one or more embodiments.

FIG. 6 schematically illustrates a flowchart of a method for generating replacement map data according to one or more other embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The present disclosure covers all modifications, equivalents, and replacements within the idea and technical scope of the present disclosure. Further, each of the features of the various embodiments of the present disclosure may be combined or combined with each other, in part or in whole, and technically various interlocking and driving are possible. Each embodiment may be implemented independently of each other or may be implemented together in an association.

In the drawings, the relative sizes of elements and regions may be exaggerated for clarity. Variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements and regions, but are to include deviations in shapes that result from, for instance, manufacturing. That is, the elements and regions illustrated in the drawings are schematic in nature and their shapes are not intended to illustrate the actual shape of a region of a device and are not intended to be limiting. In other instances, well-known structures and devices are shown in block diagram form to avoid unnecessarily obscuring various embodiments.

It will be understood that when a constituent element or layer is referred to as being “on,” “connected to,” or “coupled to” another constituent element or layer, it can be directly on, connected to, or coupled to the other constituent element or layer, or one or more intervening constituent elements or layers may be present. In addition, it will also be understood that when a constituent element or layer is referred to as being “between” two constituent elements or layers, it can be the only constituent element or layer between the two constituent elements or layers, or one or more intervening constituent elements or layers may also be present.

Electrically connecting two constituent elements includes directly connecting two constituent elements and connecting the same with another constituent element therebetween. The other constituent element may include a switch, a resistor, and a capacitor. When the embodiments are described, an expression of connection signifies electrical connection when an expression of direct connection is not provided.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression such as “at least one of A and B” and “at least one of A or B” may include A, B, or A and B. As used herein, “or” generally means “and/or,” and the term “and/or” includes any and all combinations of one or more of the associated listed items. For example, the expression such as “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing particular embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

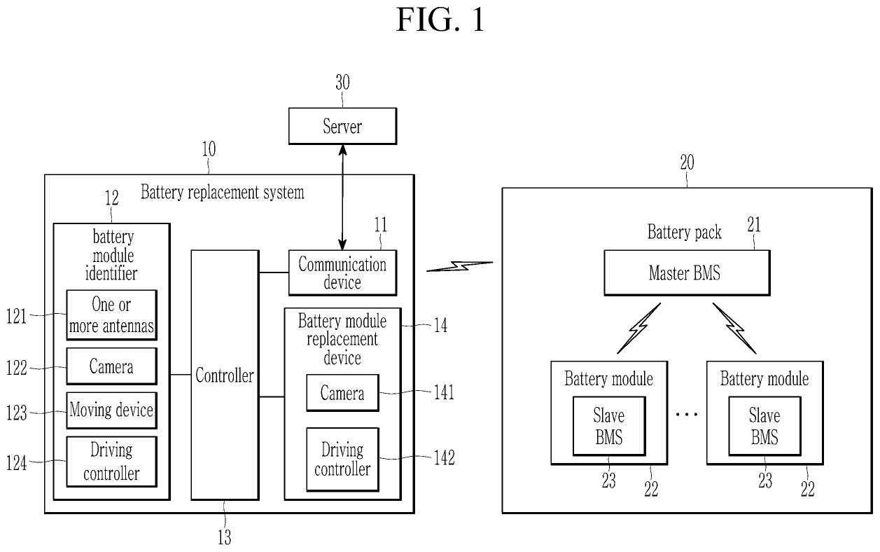

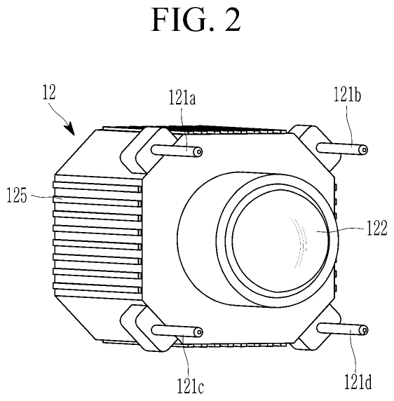

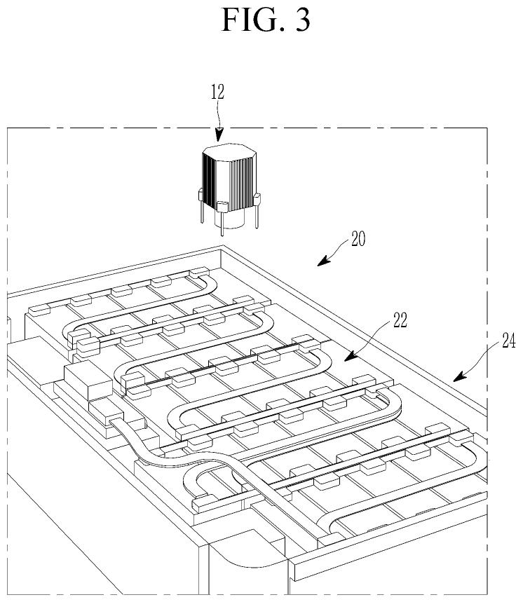

FIG. 1 schematically illustrates a battery replacement system according to one or more embodiments. In addition, FIG. 2 illustrates a perspective view of an example of a module identification device according to one or more embodiments, and FIG. 3 illustrates a method of identifying a position of a battery module by a module identification device according to one or more embodiments.

Referring to FIG. 1, a battery replacement system 10 according to one or more embodiments may include a communication device 11, a battery module identifier (e.g., module identification device) 12, a controller (e.g., control device, or a second controller) 13, and a battery module replacement device 14.

The communication device 11 may perform a wired/wireless communication function between the battery replacement system 10 and an external device (for example, a battery pack 20, a server 30, or an electronic device in which the battery pack 20 is installed). For example, the communication device 11 may communicate with a master battery management system (BMS) of the battery pack 20 in a wireless communication method (for example, Wi-Fi, Bluetooth, Zigbee, and the like). In addition, for example, the communication device 11 may communicate with the server 30 in a wired or wireless communication method.

The battery module identifier 12 may identify a position of a battery module 22 from the battery pack 20 (hereinafter, referred to as a “target battery pack”) that is received in a replacement location. The battery module identifier 12 may include one or more antennas (e.g., an antenna module) 121, a camera 122, a moving device 123, and a driving controller (e.g., driving control device, or a first controller) 124.

The one or more antennas 121 may receive a beacon signal that is wirelessly transmitted from the target battery pack 20. The one or more antennas 121 may be a multi-channel antenna including a plurality of antennas that are spaced apart from each other. Referring to FIG. 2 as an example, the one or more antennas 121 may be a 4-channel antenna including four antennas 121a to 121d protruding in one direction from a body 125 of the battery module identifier 12. The four antennas 121a to 121d may be located to be spaced apart from each other.

The camera 122 may capture the battery modules 22 configuring the target battery pack 20 from an upper portion of the target battery pack 20. The battery pack 20 may include a plurality of battery modules 22 accommodated inside a housing 24. The camera 122 may obtain image data including image information about a disposition structure of the battery modules 22 configuring the target battery pack 20 by capturing one or more images of the inside of the target battery pack 20. If the housing of the target battery pack 20 includes an upper cover, the camera 122 may capture the inside of the target battery pack 20 in a state in which the upper cover of the target battery pack 20 is removed, so that one or more images of the disposition structure of the battery modules 22 may be captured.

Referring to FIG. 1, the moving device 123 may control the movement of the battery module identifier 12. For example, if the target battery pack 20 is received at a replacement location, the moving device 123 may control the movement of the battery module identifier 12, such that the battery module identifier 12 is located above the target battery pack 20, as shown in FIG. 3. In addition, after position information of the battery module 22 (hereinafter, referred to as “target battery module”), which is a replacement target, is obtained from the target battery pack 20, the movement of the battery module identifier 12 may be controlled so that the battery module identifier 12 moves away from the upper portion of the target battery pack 20, and moves to an initial position.

The moving device 123 may include a rail device for moving along a rail. The moving device 123 may include a robot arm capable of multi-axis movement. In addition to this, various types of moving devices 123 may be used to move the body 125 of the battery module identifier 12, to which the one or more antennas 121 and the camera 122 are mounted, to the upper portion of the battery pack 20.

If the one or more antennas 121 and the camera 122 are installed to be fixed to a corresponding position (for example, the upper portion of the target battery pack 20), the moving device 123 may be omitted.

The driving controller 124 may control an overall operation of the battery module identifier 12. The driving controller 124 may control the movement of the battery module identifier 12 by controlling the driving of the moving device 123. The driving controller 124 may control the one or more antennas 121 so that each antenna of the one or more antennas 121 receives a beacon signal transmitted from a slave BMS 23 of the battery pack 20. The driving controller 124 may control the camera 122 to capture the disposition structure of the battery modules 22 configuring the target battery pack 20. The driving controller 124 may detect position information of the battery module 22 that has transmitted the beacon signal based on the beacon signal received through the one or more antennas 121, and based on the image data of the target battery pack 20 captured by the camera 122.

If the beacon signal is received through the one or more antennas 121, the driving controller 124 may detect a position of a signal source (e.g., the slave BMS 23) that has transmitted a corresponding beacon signal based on a received signal strength difference between respective antennas 121, and may generate position information corresponding to the detected position. Because a method of detecting a position of a signal source that transmitted a corresponding signal based on a signal strength of a signal received at different positions is a well-known technique in the field of position detection technology, a detailed description thereof will be omitted.

The driving controller 124 may receive image data obtained by capturing one or more images of the battery modules 22 from the camera 122. Image data captured by the camera 122 may include image information on how each battery module 22 is located inside the battery pack 20. The driving controller 124 may identify each battery module 22 indicated by the image data, which is captured by the camera 122, through image recognition. That is, the drive controller 124 detects an area in which each battery module 22 is located (hereinafter, referred to as a “module area”) from image data of the target battery pack 20, the image data being captured by the camera 122. The driving controller 124 may generate module area information for each battery module 22 configuring the target battery pack 20 based on the detected module areas, as described above. The module area information of each battery module 22 may include coordinate information about the area occupied by each battery module 22 in the image data.

The drive controller 124 may compare the module area information of each battery module 22 detected through the camera 122, and the position information of the slave BMS 23 detected through the one or more antennas 121, to obtain the position information of the battery module 22 that has transmitted the beacon signal.

Referring to FIG. 2, a relative position between each of the antennas 121a to 121d and the camera 122 may remain fixed. Accordingly, the driving controller 124 may know in advance the relative positional relationship between each of the antennas 121a to 121d and the camera 122. In addition, the driving controller 124 may convert the position information of the slave BMS 23 detected through the one or more antennas 121, and the module area information of each battery module 22 detected through the camera 122, into coordinate information on the same virtual coordinate plane (or coordinate space). Accordingly, the driving controller 124 may identify which battery module 22 includes the slave BMS 23 that transmitted the beacon signal by comparing the position information of the slave BMS 23 detected through the one or more antennas 121, and the module area information of each battery module 22 detected through the camera 122, on the same coordinate plane (or coordinate space).

If the position of the battery module 22 that transmitted the beacon signal is identified, the driving controller 124 may generate position information of the corresponding battery module 22 by using module area information of the corresponding battery module 22 and by using identification information (e.g., identification information of the corresponding battery module or slave BMS) as detected from the beacon signal.

If the position information of the battery module 22 is generated, the driving controller 124 may transmit the position information to the controller 13. When transmitting the position information, the driving controller 124 may transmit the image data of the battery modules 22 captured through the camera 122 to the controller 13, along with the position information.

The controller 13 may manage and control the overall operation of the battery replacement system 10. The controller 13 may detect reception of the target battery pack 20 at a replacement location. The controller 13 may detect the reception of the target battery pack 20 at a replacement location based on a control input from an operator or a user. The controller 13 may automatically detect the reception of the target battery pack 20 at a replacement location through image recognition. The controller 13 may automatically detect the reception of the target battery pack 20 at the replacement location through a sensor (e.g., predetermined sensor), such as a pressure sensor, a weight sensor, and an optical sensor. The controller 13 may automatically detect the reception of the target battery pack 20 at the replacement location through wireless communication with an electronic device, such as an electric vehicle or the like, in which the target battery pack 20 is received.

The controller 13 may communicate with the server 30 and the target battery pack 20 to perform authentication of the reception of the target battery pack 20 in the replacement location. The controller 13 may receive authentication information from the target battery pack 20 through wireless communication. The authentication information received from the target battery pack 20 may include identification information of the target battery pack 20, identification information of the master BMS 21 included in the target battery pack 20, and the like. If the authentication information is received from the target battery pack 20, the controller 13 may request authentication of the target battery pack 20 by transmitting it to the server 30.

The server 30 may store and manage information about battery packs registered in the server 30. The battery pack information stored in the server 30 may include identification information of each battery pack, identification information of the master BMS mounted on each battery pack, identification information of battery modules included in each battery pack, replacement history information for each battery pack (e.g., replacement date, replacement location, identification information of a new battery module replaced, reason for replacement, and the like), and warranty information (free replacement period and the like). If the authentication information of the target battery pack 20 is received from the battery replacement system 10, the server 30 may perform an authentication procedure on the target battery pack 20 based on the received authentication information and battery pack information stored in the server 30. For example, the server 30 may check whether the corresponding target battery pack 20 is registered in the server 30 based on the received authentication information of the target battery pack 20 to thereby check whether the target battery pack 20 is genuine (e.g., authorized). In addition, for example, the server 30 may check quality assurance information of the corresponding battery pack based on the received authentication information of the target battery pack 20 to check whether the target battery pack 20 is subject to battery module replacement. If the authentication process for the target battery pack 20 is completed, the server 30 may transmit an authentication result to the battery replacement system 10.

To reduce or prevent the likelihood of illegal access to the battery pack 20, an authentication process for the battery replacement system 10 may be performed by the target battery pack 20. To this end, if the authentication of the target battery pack 20 is successful, the controller 13 of the battery replacement system 10 may transmit an authentication code (for example, a one-time password (OTP)) to the master BMS 21 of the target battery pack 20. The master BMS 21 receiving the authentication code may perform an authentication process for the battery replacement system 10 by using the received authentication code. If the authentication of the battery replacement system 10 is successful, the master BMS 21 may permit the battery replacement system 10 to access the target battery pack 20. That is, only if the authentication of the battery replacement system 10 is successful, the master BMS 21 may control the slave BMS 23 so that information on the target battery pack 20 (for example, information on a defective battery module to be replaced) may be transmitted to the battery replacement system 10, or so that a beacon signal for identifying a defective battery module may be transmitted.

If the authentication of the target battery pack 20 is successfully completed, the controller 13 may operate the battery module identifier 12 to obtain position information of a target battery module that is to be replaced in the target battery pack 20.

If the authentication process is successfully completed, the master BMS 21 of the target battery pack 20 may enter a replacement mode to transmit information (for example, the number of battery modules 22 configuring the target battery pack(s) 20, identification information of the battery module 22 (e.g., identification information of the battery module 22 or the slave BMS 23 included therein), specification information, and the like) of each battery module 22 configuring the target battery pack 20 to the battery replacement system 10. In addition, the master BMS 21 may transmit information (for example, the number of defective battery modules, identification information of the defective battery module(s) (identification information of the corresponding battery module 22 or the slave BMS 23 included therein), error code, and state information (e.g., voltage, current, temperature, and the like) on the defective battery module to the battery replacement system 10. Here, the error code may be an identification code indicating a defect factor of the corresponding battery module 22.

In addition, the master BMS 21 may control the slave BMS 23 so that the slave BMS 23 of each battery module 22 sequentially transmits beacon signals.

If a slave BMS 23 of the target battery pack 20 transmits a beacon signal, the controller 13 of the battery replacement system 10 may use the battery module identifier 12 to obtain position information of the corresponding battery module 22. If the position information of each battery module 22 is obtained in this way, the controller 13 may determine a target battery module among the battery modules 22 whose position is identified based on the information on the defective battery module received from the target battery pack 20.

The battery module 22 may be suitably replaced not only if the battery cells configuring the battery module 22 are defective, but also if the slave BMS 23 mounted on the battery module 22 is defective. If the slave BMS 23 is defective, the slave BMS 23 may not normally transmit a beacon signal. Accordingly, the controller 13 may determine the battery module 22 in which transmission of the beacon signal is not detected among the battery modules for which module area information is detected through the camera 122 as the target battery module. In this case, based on the information received from the target battery pack 20, the controller 13 may determine the identification information of the battery module that is determined to have not transmitted a beacon signal among the battery modules 22 configuring the target battery pack 20 as identification information of the target battery module, and the controller 13 may generate position information to include the identification information determined in this way and to include the module area information of the target battery module obtained through the camera 122.

Meanwhile, the master BMS 21 of the target battery pack 20 may control the slave BMSs 23 to transmit a beacon signal only to the defective battery modules, thereby reducing power consumption. That is, after entering the replacement mode, the master BMS 21 may control the corresponding slave BMSs 23 so that the slave BMS 23 of the defective battery module sequentially transmits a beacon signal. In this case, whenever the slave BMS 23 of the defective battery module included in the target battery pack 20 transmits a beacon signal, the controller 13 of the battery replacement system 10 may use the battery module identifier 12 to obtain position information of the target battery module.

If the target battery module is identified through the battery module identifier 12, the controller 13 may compare the information of the defective battery module received from the target battery pack 20 with the identification information of the target battery module detected from the beacon signal to verify the target battery module detected through the battery module identifier 12. That is, the controller 13 may verify whether the battery module identified as the target battery module by the battery module identifier 12 is a defective battery module.

The controller 13 may also check whether there is a battery module that has not transmitted a beacon signal among battery modules identified as defective battery modules from the target battery pack 20 based on the received information corresponding to the defective battery module. If there is a battery module that has not transmitted a beacon signal among battery modules notified as the defective battery modules from the target battery pack 20, the controller 13 may notify the master BMS 21. The master BMS 21 may control the slave BMSs 23 so that the slave BMS 23 of each battery module 22 sequentially transmits a beacon signal. The controller 13 may identify the position of the corresponding battery module 22 by using the battery module identifier 12 whenever each slave BMS 23 transmits a beacon signal. In addition, the controller 13 may detect the battery module 22 that has not transmitted a beacon signal among the battery modules 22 for which module area information is obtained through the camera 122 based on the position of each battery module 22 identified, and may determine the battery module 22 as the target battery module. In this case, based on the information received from the target battery pack 20, the controller 13 may determine the identification information of the battery module that is determined to have not transmitted a beacon signal as identification information of the target battery module, and may generate the position information to include the determined identification information and to include the module area information of the target battery module obtained through the camera 122.

If the target battery module is determined in the above-described manner, the controller 13 may generate replacement map data to include the information to include the image data of the target battery pack 20 captured by the camera 122 and to include the position information indicating the module area of the target battery module within the corresponding image data. If the replacement map data is generated, the controller 13 may transmit the replacement map data to the battery module replacement device 14. In addition, the battery module replacement device 14 may be operated so that the battery module replacement device 14 automatically replaces the target battery module with a new battery module based on the replacement map data.

The battery module replacement device 14 may receive the replacement map data from the controller 13, and may replace the target battery module with a new battery module based on this. The battery module replacement device 14 may include a camera 141 and a driving controller 142.

The camera 141 may capture the battery modules 22 configuring the target battery pack 20 from an upper portion of (e.g., from a position above) the target battery pack 20.

The driving controller 142 may control an overall operation of the battery module replacement device 14. The driving controller 142 may control the camera 141 to capture the disposition structure of the battery modules 22 configuring the target battery pack 20. The driving controller 142 may receive image data obtained by capturing one or more images of the battery modules 22 of the target battery pack 20 from the camera 141. The image data captured by the camera 141 may include image information on how each battery module 22 is located inside the battery pack 20. The driving controller 142 may detect a module area (or disposition shape) occupied by each battery module 22 via image data through image recognition of the image data captured by the camera 141. The driving controller 142 may generate module area information of each battery module 22 based on the detected module area of each battery module 22.

If the replacement map data is received from the controller 13, the driving controller 142 may determine an operation path for battery module replacement operation, based on the module area information of each battery module 22 obtained through the camera 141 and based on the received replacement map data. In addition, the driving controller 142 may perform a replacement operation of replacing the target battery module inside the target battery pack 20 with a new battery module based on the determined operation path.

The battery module replacement device 14 is a device capable of automatically attaching and detaching the battery module 22 to and from the battery pack 20, and may be configured in the form of a robot arm or a jig.

If the replacement of the defective battery module is completed by the battery module replacement device 14, the controller 13 may transmit identification information of a newly installed battery module to the master BMS 21 of the target battery pack 20. If information of the new battery module is received from the battery replacement system 10, the master BMS 21 of the target battery pack 20 may store the information in an internal memory for management of the battery module 22.

In addition, the master BMS 21 of the target battery pack 20 may perform a diagnosis process to check whether the battery module is normally replaced. For example, the master BMS 21 may verify whether the information of the new battery module, which is received from the battery replacement system 10 through communication with the slave BMS of the new battery module, matches the information of the actually installed battery module. In addition, for example, the master BMS 21 may detect state values (a voltage, a current, a temperature, and the like) of the new battery module, and may verify whether the new battery module normally operates based on the detected state values. If the diagnosis process is successfully completed, the master BMS 21 may notify the battery replacement system 10 of the diagnosis result.

If the diagnosis of the new battery module is successfully completed, the controller 13 may control the battery module replacement device 14 to complete assembly of the target battery pack 20. In addition, the controller 13 may transmit information about battery module replacement details (e.g., replacement date, identification information of defective battery module and new battery module, reason for replacement, and the like) of the target battery pack 20 to the server 30. If the battery module replacement details of the target battery pack 20 are received from the battery replacement system 10, the server 30 may update replacement history information of a corresponding battery pack based on the received battery module replacement details.

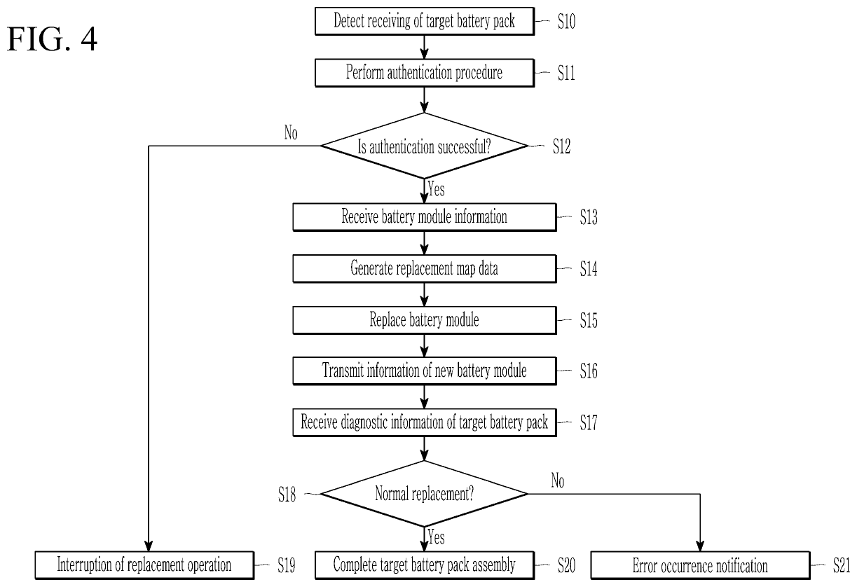

Hereinafter, a battery replacement method of the battery replacement system 10 will be described in detail with reference to FIG. 4 to FIG. 6. The methods described below may be performed by the battery replacement system 10 described with reference to FIG. 1 to FIG. 3.

FIG. 4 schematically illustrates a flowchart of a battery replacement method according to one or more embodiments.

Referring to FIG. 4, the battery replacement system 10 may detect the reception of the target battery pack 20 at the replacement location (S10).

In operation S10, the battery replacement system 10 may detect the reception of the target battery pack 20 at a replacement location based on a control input from an operator or a user. The battery replacement system 10 may automatically detect the reception of the target battery pack 20 at a replacement location through image recognition. In addition, the battery replacement system 10 may automatically detect the reception of the target battery pack 20 at the replacement location through a sensor (e.g., predetermined sensor), such as a pressure sensor, a weight sensor, and/or an optical sensor. In addition, the battery replacement system 10 may automatically detect the reception of the target battery pack 20 at the replacement location through wireless communication with an electronic device, such as an electric vehicle or the like, in which the target battery pack 20 is received.

As the target battery pack 20 is received at the replacement location, the battery replacement system 10 may communicate with the target battery pack 20 and the server 30 to perform an authentication procedure for the target battery pack 20 (S11).

In operation S11, the battery replacement system 10 may receive authentication information from the target battery pack 20 through wireless communication, and may transmit the authentication information to the server 30 to request authentication of the target battery pack 20. Upon receiving this, the server 30 performs an authentication procedure on the target battery pack 20 based on the authentication information of the target battery pack 20 and based on information on the battery packs registered in the server 30, and may transmit the authentication result to the battery replacement system 10.

In operation S11, the battery replacement system 10 may request authentication by transmitting an authentication code (for example, an OTP) to the master BMS 21 of the target battery pack 20. Upon receiving this, the master BMS 21 may perform an authentication procedure by using the received authentication code, and may transmit the authentication result to the battery replacement system 10. In addition, if authentication is successful, access of the battery replacement system 10 to the target battery pack 20 may be allowed.

If the authentication in operation S11 is not successful (S12; No), the battery replacement system 10 may stop a battery module replacement operation for the target battery pack 20 (S19), and may transmit authentication failure information to the operator.

On the other hand, if the authentication in operation S11 is successful (S12; Yes), the battery replacement system 10 may receive battery module information from the master BMS 21 of the target battery pack 20 through wireless communication (S13). The battery module information received in operation S13 may include information on the battery module 22 configuring the target battery pack 20 (for example, the number of battery modules 22 configuring the target battery pack 20, identification information of each battery module 22 (e.g., identification information of the battery module 22 or the slave BMS 23 included therein), specification information, and the like). The battery module information received in operation S13 may include information on the defective battery module (for example, the number of defective battery modules, identification information of the defective battery module (e.g., identification information of the corresponding battery module 22 or the slave BMS 23 included therein), error code, and state information (e.g., voltage, current, temperature, and the like).

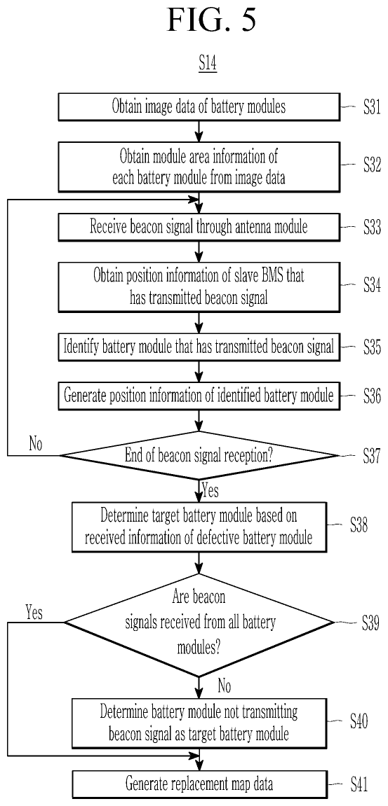

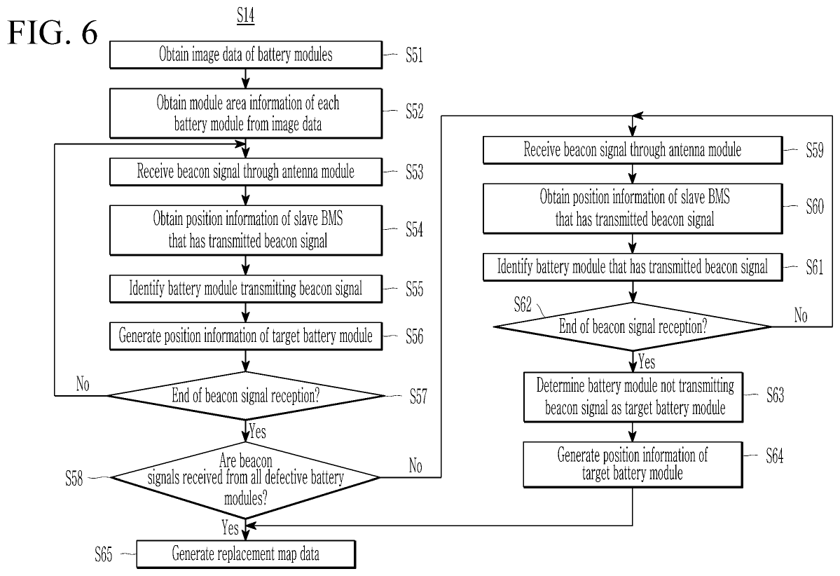

The battery replacement system 10 may also operate the battery module identifier 12 to obtain position information of the target battery module to be replaced, and may generate replacement map data (S14). A method for generating the replacement map data will be described in detail with reference to FIG. 5 and FIG. 6.

If the replacement map data is obtained, the battery replacement system 10 may automatically replace the target battery module with a new battery module by operating the battery module replacement device 14 based on the replacement map data (S15). If the replacement operation is completed, the battery replacement system 10 may transmit information (e.g., identification information of a battery module or slave BMS) corresponding to a new battery module that is newly installed in the target battery pack 20, the information being transmitted to the master BMS 21 of the target battery pack 20 (S16).

The master BMS 21 of the target battery pack 20 receiving the information on the new battery module from the battery replacement system 10 may perform a diagnosis process to confirm whether the battery module is normally replaced. In addition, the master BMS 21 may transmit diagnostic information including a diagnostic result to the battery replacement system 10 (S17).

If it is determined that the battery module has been normally replaced based on the received diagnostic information (S18; Yes), the battery replacement system 10 may complete the assembly of the target battery pack 20 (S20). On the other hand, if it is determined that the replacement operation has not been performed normally (S18; No), the battery replacement system 10 may notify the operator that an error has occurred in the replacement operation (S21).

FIG. 5 schematically illustrates a flowchart of a method for generating replacement map data according to one or more embodiments.

Referring to FIG. 5, the battery replacement system 10 may obtain image data of the battery modules 22 inside the target battery pack 20 via the camera 122 (S31). The image data obtained through operation S31 may include image information about the disposition structure of the battery modules 22. Accordingly, the battery replacement system 10 may detect module area information of each battery module from the obtained image data (S32). In operation S32, the module area information of each battery module 22 detected from the image data may include coordinate information corresponding to a disposition position and a disposition shape of each battery module 22 represented in the image data.

The master BMS 21 of the target battery pack 20 that has successfully authenticated with the battery replacement system 10 may control the slave BMSs 23 so that the slave BMS 23 of each battery module 22 sequentially transmits beacon signals. Accordingly, the battery replacement system 10 may receive the beacon signal transmitted from the slave BMS 23 through the one or more antennas 121 (S33).

If the beacon signal is received, the battery replacement system 10 may obtain position information of the slave BMS 23 that has transmitted the beacon signal based on the received signal strength from each antenna 121 (S34). In addition, the battery replacement system 10 may compare the module area information of each battery module 22 obtained through the camera 122, and the position information of the slave BMS 23 obtained through the one or more antennas 121, to identify which of the battery modules 22 configuring the target battery pack 20 has transmitted the beacon signal (S35). If the battery module transmitting the beacon signal is identified, the battery replacement system 10 may generate position information to include the module area information obtained through operation S32 and to include the identification information obtained from the beacon signal for the identified battery module (S36).

The aforementioned operations S33 to S36 may be repeatedly performed whenever the beacon signal transmitted from the target battery pack 20 is received by the battery replacement system 10 (S37; No).

If the beacon signal reception from the target battery pack 20 ends (S37; Yes), that is, if no beacon signal is received from the target battery pack 20 for a period of time (e.g., predetermined period of time) or longer, the battery replacement system 10 may determine a target battery module among battery modules whose position information is identified through the battery module identifier 12 based on the information on the defective battery module received from the target battery pack 20 (S38). That is, the battery replacement system 10 my compare the identification information included in the position information of each battery module with the identification information of the defective battery module received from the target battery pack 20 to determine a target battery module among battery modules whose position information is identified through the battery module identifier 12 (S38).

Meanwhile, the battery replacement system 10 may check whether beacon signals are received from all battery modules configuring the target battery pack 20 (S39). For example, if the number of battery modules included in the information received from the target battery pack 20 and the number of identification information obtained from the beacon signal are different, the battery replacement system 10 may determine that a beacon signal has not been received from some of the battery modules (S39; No).

If it is determined that the beacon signal is not received from some of the battery modules 22, the battery replacement system 10 may detect a battery module that is determined to not transmit a beacon signal as a target battery module (S40). For example, the battery replacement system 10 may detect a battery module for which position information is not generated by a received beacon signal among battery modules whose module area is identified from image data, and may determine the battery module as a target battery module.

If the target battery module is determined, or if beacon signals are received from all battery modules (S39; Yes), the battery replacement system 10 may generate replacement map data including position information of the target battery module and image data captured by the camera 122 (S41).

FIG. 6 schematically illustrates a flowchart of a method for generating replacement map data according to one or more other embodiments. In the following description, among steps of FIG. 6, detailed descriptions of steps performed in the same manner as the method for generating the replacement map data described with reference to FIG. 5 will be omitted.

Referring to FIG. 6, the battery replacement system 10 may obtain image data of the battery modules 22 inside the target battery pack 20 through the camera 122 (S51). In addition, the battery replacement system 10 may detect module area information of each battery module from the image data (S52).

The master BMS 21 of the target battery pack 20 may control the slave BMSs 23 so that the slave BMS 23 of the defective battery module sequentially transmit beacon signals. Accordingly, the battery replacement system 10 may receive the beacon signal transmitted from the slave BMS 23 of the defective battery module through the one or more antennas 121 (S53).

If the beacon signal is received, the battery replacement system 10 may obtain position information of the slave BMS 23 that has transmitted the beacon signal based on the received signal strength from each antenna 121 (S54). In addition, the battery replacement system 10 may compare the module area information of each battery module 22 obtained through the camera 122, and the position information of the slave BMS 23 obtained through the one or more antennas 121, to thereby identify which of the battery modules 22 configuring the target battery pack 20 has transmitted the beacon signal (S55). If the battery module transmitting the beacon signal is identified, the battery replacement system 10 may determine the identified battery module as a target battery module, and may generate position information of the target battery module (S56).

The aforementioned operations S53 to S56 may be repeatedly performed whenever the beacon signal transmitted from the target battery pack 20 is received by the battery replacement system 10.

If the beacon signal reception from the target battery pack 20 ends (S57; Yes), that is, if no beacon signal is received from the target battery pack 20 for a period of time (e.g., predetermined period of time) or longer, the battery replacement system 10 may check whether beacon signals are received from all defective battery modules of the target battery pack 20 based on the information on the defective battery module received from the target battery pack 20 (S58). For example, if the number of defective battery modules included in the information received from the target battery pack 20 and the number of identification information obtained from the beacon signal are different, the battery replacement system 10 may determine that a beacon signal has not been received from one or more of the defective battery modules (S58; No).

If it is determined that the beacon signal is not received from some of the defective battery modules, the battery replacement system 10 may notify the master BMS 21 of this. The master BMS 21 notified of this may control the slave BMSs 23 so that the slave BMS 23 of each battery module 22 sequentially transmits a beacon signal. Accordingly, the battery replacement system 10 may receive the beacon signal transmitted from the slave BMS 23 through the one or more antennas 121 (S59).

If the beacon signal is received, the battery replacement system 10 may obtain position information of the slave BMS 23 that has transmitted the beacon signal based on the received signal strength from each antenna configuring the one or more antennas 121 (S60). In addition, the battery replacement system 10 may compare the module area information of each battery module 22 obtained through the camera 122 and the position information of the slave BMS 23 obtained through the one or more antennas 121 to identify which of the battery modules 22 configuring the target battery pack 20 has transmitted the beacon signal (S61).

The aforementioned operations S59 to S61 may be repeatedly performed whenever the beacon signal transmitted from the target battery pack 20 is received by the battery replacement system 10.

If the beacon signal reception from the target battery pack 20 is terminated (S62; Yes), the battery replacement system 10 detects a battery module determined to have not transmitted a beacon signal to determine it as a target battery module (S63), and it may generate position information of the target battery module (S64). For example, the battery replacement system 10 may detect a battery module that is not identified as having transmitted a beacon signal among battery modules whose module area is identified from image data, and may determine it as a target battery module.

If the position information of the target battery module is generated through operation S56 and operation S64 (e.g., S58; Yes), the battery replacement system 10 may generate replacement map data including the generated position information of the target battery module and the image data captured by the camera 122 (S65).

According to the above-described embodiments, if the battery module of the battery pack 20 may be suitably replaced, the processes, in which the battery pack 20 is received, the defective battery module is replaced with a new battery module, and then the battery pack 20 is reassembled, may be automated. In addition, if some of the battery modules of the battery pack 20 are defective, only defective battery modules may be automatically replaced without replacing the battery pack itself, thereby reducing replacement cost and reducing or preventing resource waste.

Meanwhile, in the above-described embodiments, the case has been described in which the obtained position information of the battery module 22 is transmitted to the controller 13 after the driving controller 124 of the battery module identifier 12 obtains the position information of the battery module 22, but the present disclosure is not limited thereto. In one or more other embodiments, a function of obtaining position information of the battery module 22 may be performed by the controller 13. For example, the driving controller 124 may transmit signal strength information of a beacon signal received through each antenna of the one or more antennas 121 and image data captured by the camera 122 to the controller 13, and the controller 13 may obtain position information of the battery module 22 based on this in the above-described manner.

Electronic or electrical devices according to the embodiments and/or other related devices or constituent elements may be realized by using appropriate hardware, firmware (e.g., an application-specific integrated circuit), software, or combinations of software, firmware, and hardware. For example, various configurations of the above-noted devices may be positioned on one integrated circuit (IC) chip or an individual IC chip. In addition, various configurations of the above-noted devices may be realized on a flexible printed circuit film, a tape carrier package (TCP), a printed circuit board (PCB), or one substrate. The electrical or mutual connections described in the present specification may, for example, be realized by the PCB, wires on different types of circuit carriers, or conductive elements. The conductive elements may, for example, include metallization, such as surface metallization and/or pins, and may include conductive polymers or ceramics. Further, electrical energy may be transmitted by electromagnetic radiation or by a light-using radio access.

In addition, the various configurations of the devices may be performed by at least one processor to perform the above-described various functions, they may be performed in at least one computing device, and they may be processes or threads for performing computer program instructions and interacting with other system constituent elements. The computer program instruction is received in a memory realizable in a computing device using a standard memory device, such as a random access memory (RAM). The computer program instruction may also be received in a non-transitory computer-readable medium, such as a CD-ROM or a flash drive.

Further, a person of ordinary skill in the art must understand that various functions of the computing device may be combined or united to a single computing device, or functions of a corresponding computing device may be dispersed to at least another computing device while not digressing from the range of the embodiments of the present invention.

While the present disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims, with functional equivalents thereof to be included therein.

### DESCRIPTION OF SOME OF THE REFERENCE CHARACTERS

10: battery replacement system
11: communication device
12: battery module identifier
121: one or more antennas
122: camera of battery module identifier
123: moving device
124: driving controller of battery module identifier
13: controller
14: battery module replacement device
141: camera of battery module replacement device
142: driving controller for battery module replacement device
20: battery pack
21: master BMS
22: battery module
23: slave BMS
30: server

What is claimed is:

1. A battery replacement system comprising:
antennas;
a camera;
a first controller configured to generate position information of a first target battery module based on image data received from the camera and corresponding to battery modules inside a battery pack, and based on a beacon signal received from the first target battery module through the antennas; and
a battery module replacement device configured to replace the first target battery module with a new battery module based on the position information.

2. The battery replacement system as claimed in claim 1, wherein the first controller is further configured to detect module areas corresponding to the battery modules based on the image data, to determine a target module area of the first target battery module based on the beacon signal, to generate the position information of the first target battery module to comprise target module area information of the first target battery module, and to generate identification information extracted from the beacon signal.

3. The battery replacement system as claimed in claim 2, wherein the first controller is further configured to determine the target module area based on a received signal strength of the antennas for the beacon signal.

4. The battery replacement system as claimed in claim 1, wherein the antennas are configured to receive beacon signals transmitted from the battery modules, and
wherein the first controller is further configured to generate position information of the battery modules based on the image data and the beacon signal.

5. The battery replacement system as claimed in claim 4, wherein the first controller is further configured to determine one of the battery modules not transmitting the beacon signal as a second target battery module, and to generate second target position information of the second target battery module based on the image data, and
wherein the battery module replacement device is further configured to replace the second target battery module with a new battery module based on the second target position information.

6. The battery replacement system as claimed in claim 5, wherein the first controller is further configured to determine one of the battery modules whose corresponding module area is not transmitting the beacon signal.

7. The battery replacement system as claimed in claim 4, further comprising a second controller configured to receive information on one of the battery modules to be replaced from the battery pack, and to receive position information of the battery modules from the first controller,
wherein the second controller is further configured to select the first target battery module based on the information of the one of the battery modules to be replaced, and to transmit first target position information of the first target battery module to the battery module replacement device.

8. The battery replacement system as claimed in claim 4, wherein the first controller is further configured to select the first target battery module based on the information of the one of the battery modules to be replaced, and to transmit position information of the first target battery module to the battery module replacement device.

9. The battery replacement system as claimed in claim 1, wherein the position information of the first target battery module comprises module area information of the first target battery module, and identification information of the first target battery module detected from the beacon signal.

10. The battery replacement system as claimed in claim 1, wherein the battery module replacement device is further configured to determine an operation path for replacing the first target battery module based on the position information of the first target battery module, and to replace the first target battery module with the new battery module based on the operation path.

11. A battery replacement method of a battery replacement system, the method comprising:
obtaining image data by capturing an image of battery modules inside a battery pack via a camera;
receiving a beacon signal from a first target battery module among the battery modules through antennas;
generating position information of the first target battery module based on the image data and the beacon signal; and
replacing the first target battery module with a new battery module based on the position information of the first target battery module.

12. The battery replacement method as claimed in claim 11, wherein the generating of the position information comprises:
detecting module areas corresponding to the battery modules from the image data;
determining a first target module area of the first target battery module from among the module areas based on the beacon signal; and
generating position information of the first target battery module to comprise module area information of the first target battery module and identification information extracted from the beacon signal.

13. The battery replacement method as claimed in claim 12, wherein the determining of the module area of the first target battery module is based on a signal strength of the antennas for the beacon signal.

14. The battery replacement method as claimed in claim 12, further comprising:
receiving beacon signals transmitted from the battery modules via the antennas;
determining a second target battery module not transmitting a beacon signal among the battery modules;
generating position information of the second target battery module based on the image data; and
replacing the second target battery module with a new battery module based on the position information.

15. The battery replacement method as claimed in claim 14, wherein the determining of the second target battery module comprises determining the second target battery module corresponds to a module area whose beacon signal is not received through the antennas.

16. The battery replacement method as claimed in claim 12, further comprising:
receiving, from the battery pack, information corresponding to a battery module to be replaced; and
determining the first target battery module based on the information.

17. The battery replacement method as claimed in claim 11, wherein the position information of the first target battery module comprises module area information of the first target battery module and identification information of the first target battery module detected from the beacon signal.

18. The battery replacement method as claimed in claim 11, wherein the replacing comprises:
determining an operation path for replacing the first target battery module based on the position information of the first target battery module; and
replacing the first target battery module with the new battery module based on the operation path.

19. The battery replacement method as claimed in claim 11, further comprising:
receiving a diagnostic result for the new battery module from the battery pack; and
completing assembly of the battery pack based on determining that the new battery module is normally replaced based on the diagnostic result.

20. The battery replacement method as claimed in claim 11, further comprising:
detecting reception of the battery pack at a replacement location; and
performing an authentication process for battery module replacement by wirelessly communicating with the battery pack.
